(19) United States
(12) Patent Application Publication
(10) Pub. No.: US 2014/0190260 A1
(43) Pub. Date: Jul. 10, 2014

(54) MEMS APPARATUS

(71) Applicant: Kuan-Wen CHEN, Taipei City (TW)

(72) Inventors: Mao-Chen LIU, Jiji Township (TW); Wen-Chieh CHOU, Guishan Township (TW); Po-Wei LU, Bade City (TW); Shu-Yi WENG, Zhunan Township (TW); Chun-Chieh WANG, Taichung City (TW)

(73) Assignee: Kuan-Wen CHEN, Taipei City (TW)

(21) Appl. No.: 14/151,622

(22) Filed: Jan. 9, 2014

(30) Foreign Application Priority Data
Jan. 9, 2013 (TW) 102100781
Jan. 9, 2013 (TW) 102100784

(51) Int. Cl. G01P 15/08

(52) U.S. Cl. CPC G01P 15/0802
USPC 73/514.35

(57) ABSTRACT

Disclosed herein is a MEMS apparatus comprising a substrate with an etched area, a proof mass disposed at the center of the etched area, and beams supporting the proof mass. The beams are disposed between peripheries of the substrate and the proof mass. The substrate comprises first and second electrodes that are parallel to an axis and extend respectively from opposite regions on the substrate. The proof mass comprises third and fourth electrodes that are parallel to the axis and extend respectively from opposite edges of the proof mass. The first and third electrodes are opposite to and interlaid with each other. The second and fourth electrodes are opposite to and interlaid with each other. With the proof mass constructed as an oxide layer optionally enclosing a connecting layer or as a silicon substrate optionally with a covering layer, the MEMS apparatus is not susceptible to the variation of temperature.

### CROSS-REFERENCE TO RELATED APPLICATIONS

This non-provisional application claims priority under 35 U.S.C. §119(a) on Patent Applications No. 102100781 and 102100784 filed in Taiwan, R.O.C. on Jan. 9, 2013, the entire contents of which are hereby incorporated by reference.

### TECHNICAL FIELD

The present invention relates to a MEMS (microelectromechanical systems) apparatus, particularly to one where a proof mass is constructed as an oxide layer optionally enclosing a connecting layer or as a silicon substrate optionally with a covering layer.

### BACKGROUND

Most semiconductor components are manufactured with a series of metal-layer and oxide-layer processes. MEMS components, a common category of semiconductor components formed by stacking metal and oxide layers on top of each other, do not require complex packaging for in them MEMS and application-specific integrated circuits (ASICs) are on the same plane. One of the applications of MEMS components is the two-axis accelerometer.

Tensile stress is usually associated with the physically deposited metal layers as compressive stress is with the chemically deposited oxide layers. The residual stress in MEMS components is thus the tension and the compression therein combined. The tension tends to warp the structure of a MEMS component upwards while the compression does the otherwise. Thin films of oxide are formed with chemical bonding and deposited at a high temperature. The structure therefore warps downwards because the bonds are strong enough to render the residual stress of the oxide layers greater than that of the metal ones.

The residual stress might be released with rapid thermal anneal (RTA) systems, but one must not overlook thermal warping resulting from the discrepancy in the coefficients of thermal expansion of the composite material. Aluminum, for example, has a coefficient of 23 ppm/° C., while a typical one of oxides is 0.5 ppm/° C., the former value 46 times the latter. Large coefficients of thermal expansion are such commonplace in MEMS components that they often distort when subject to the variation of temperature.

### SUMMARY

In light of the above, the present invention discloses a MEMS (microelectromechanical systems) apparatus whose structure and movement are highly stable and not susceptible to the variation of temperature, due to a proof mass thereof being constructed as an oxide layer optionally enclosing a connecting layer or as a silicon substrate optionally with a covering layer.

The MEMS apparatus provided by this disclosure comprises a substrate, a proof mass, and beams. The substrate comprises first electrodes, second electrodes, a first region, a second region, and an etched area. The etched area is located at the center of the substrate. The first and second regions are opposite each other. The first electrodes are equidistantly located in the first region. The second electrodes are equidistantly located in the second region. The proof mass, disposed at the center of the substrate, comprises third electrodes, fourth electrodes, a first edge, and a second edge. The first and second edges are opposite each other. The third electrodes are equidistantly located on the first edge. The fourth electrodes are equidistantly located on the second edge. The beams, respectively disposed between a periphery of the substrate and a periphery of the proof mass, are configured to support the proof mass so that the proof mass and the substrate are a first distance apart. Each of the first electrodes is parallel to an axis and extends along the axis towards the first edge from the first region by a second distance. Each of the third electrodes is parallel to the axis and extends along the axis towards the first region from the first edge by a third distance. The first and third electrodes are opposite to and interlaid with each other. The second and third distances are greater than half of but no greater than the first distance. Each of the second electrodes is parallel to the axis and extends along the axis towards the second edge from the second region by the second distance. Each of the fourth electrodes is parallel to the axis and extends along the axis towards the second region from the second edge by the third distance. The second and fourth electrodes are opposite to and interlaid with each other.

### BRIEF DESCRIPTION OF THE DRAWING

The present invention will become more fully understood from the detailed description given hereinbelow and the accompanying drawings which are given by way of illustration only and thus are not limitative of the present invention and wherein:

FIG. 1 illustrates a MEMS apparatus in accordance with one embodiment of the present invention.

FIGS. 2A through 2E are diagrams illustrating a manufacturing process of the MEMS apparatus in FIG. 1, in accordance with one embodiment of the present invention.

FIGS. 3A through 3E are diagrams illustrating another manufacturing process of the MEMS apparatus in FIG. 1, in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

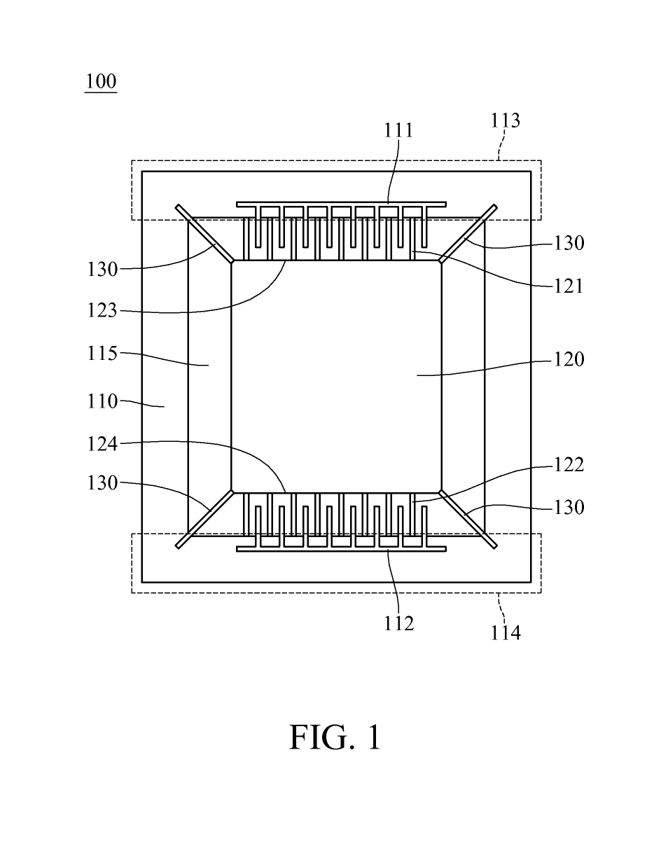

Please refer to FIG. 1, which depicts a MEMS (microelectromechanical systems) apparatus 100 comprising a substrate 110, a proof mass 120, and beams 130. The substrate 110 comprises first electrodes 111, second electrodes 112, a first region 113, a second region 114, and an etched area 115. The etched area 115 is located at the center of the substrate 110. The first region 113 and the second region 114 are opposite each other. The first electrodes 111 are equidistantly located in the first region 113. The second electrodes 112 are equidistantly located in the second region 114. In one embodiment, the substrate 110 is made of silicon. The respective number of the first electrodes 111 and the second electrodes 112 may be, but not necessarily, eight.

The proof mass 120, disposed at the center of the substrate 110, comprises third electrodes 121, fourth electrodes 122, a first edge 123, and a second edge 124. The first edge 123 and the second edge 124 are opposite each other. The third electrodes 121 are equidistantly located on the first edge 123. The fourth electrodes 122 are equidistantly located on the second edge 124. The respective number of the third electrodes 121 and the fourth electrodes 122 may be, but not necessarily, eight.

The beams 130, respectively disposed between a periphery of the substrate 110 and a periphery of the proof mass 120, are configured to support the proof mass 120 so that the proof mass 120 and the substrate are a separated by a distance. The number of the beams 130 may be, but not limited to, two, four, or six. In one embodiment, the beams 130 are made of metal.

Each of the first electrodes 111 is parallel to an axis and extends along the axis towards the first edge 123 from the first region 113. Each of the third electrodes 121 is parallel to the axis and extends along the axis towards the first region 113 from the first edge 123. The distances by which each of the first electrodes 111 or each of third electrodes 121 extends are greater than half of but no greater than the distance between the proof mass 120 and the substrate 110; the opposing first electrodes 111 and third electrodes 121 are therefore interlaid with each other. Similarly, with each of the second electrodes 112 parallel to and extending along the axis towards the second edge 124 from the second region 114, and each of the fourth electrodes 122 parallel to and extending along the axis towards the second region 114 from the second edge 124, the opposing second electrodes 112 and fourth electrodes 122 are interlaid with each other.

The MEMS apparatus 100 can be used as an accelerometer. A change in the outside environment induces the proof mass 120 to receive an acceleration, which is in turn received by the third electrodes 121 and the fourth electrodes 122. The overlapping areas between the first electrodes 111 and the third electrodes 121 have a coupling capacitance, the difference of whose values before and after the proof mass 120 receives the acceleration is detected. By the same token, the accelerometer also detects the difference of the coupling capacitance formed between the second electrodes 112 and the fourth electrodes 122.

In a first embodiment, the proof mass 120 is structured as an oxide layer in the MEMS apparatus 100. The oxide layer may be silicon dioxide and may have a coefficient of thermal expansion of 0.5 ppm/° C. The oxide layer may further enclose a connecting layer (not shown in FIG. 1) to form the proof mass 120. The connecting layer may be made of tungsten and may have a coefficient of thermal expansion of 4 ppm/° C. In a second embodiment, the proof mass 120 is structured as a silicon substrate, whose coefficient of thermal expansion may be 3 ppm/° C. The silicon substrate may further accompany a covering layer to form the proof mass 120. The covering layer, not shown in FIG. 1, may be made of metal or oxide and may have a coefficient of thermal expansion of 0.5 ppm/° C. The quotients of the coefficients of the aforementioned structures, e.g. 3 or 4 divided by 0.5, are much smaller than that if the proof mass 120 was aluminum-based. The MEMS apparatus 100 of the first or second embodiments can thus function as an accelerometer without the imperfection resulting from warpage.

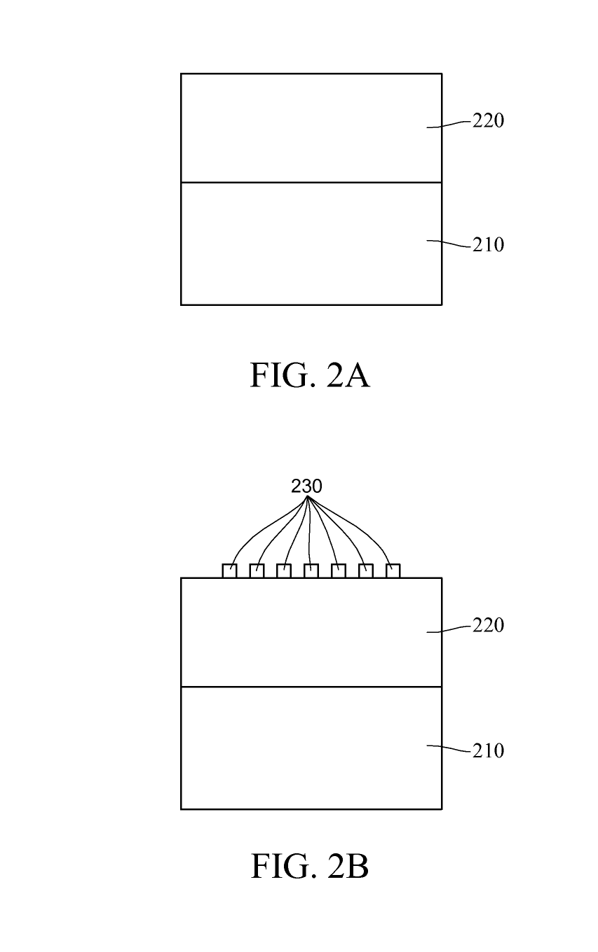

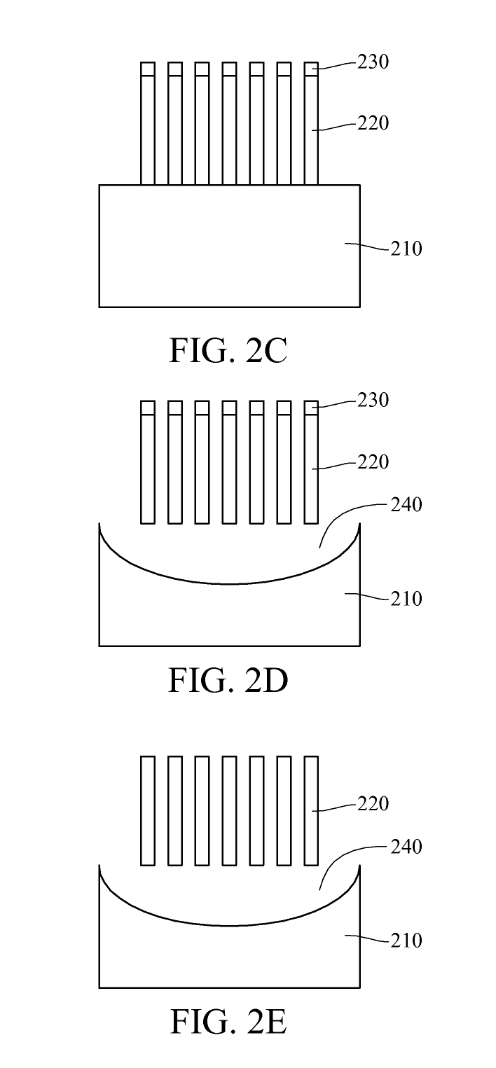

Please refer to FIGS. 2A through 2E, which illustrates a manufacturing process of the MEMS apparatus 100 in accordance to the first embodiment. In FIG. 2A, an oxide layer 220 (and optionally a connecting layer) is grown on a substrate 210 by means of thin film deposition. Photoresists 230 are then applied on top of the oxide layer 220, as shown in FIG. 2B. Using photolithography (exposure, developing, etc), the resists 230 define a hard mask protecting portions of the oxide layer 220 that are to be kept. In FIG. 2C, the unprotected portions of the oxide layer 220 are dry-etched away. The anisotropic dry etching may be, but not necessarily, reactive-ion etching (RIE), for example one based on inductively coupled plasma (ICP). According to FIG. 2D, the substrate 210, masked by the protected portions of the oxide layer 220, is also partly removed by the said etching, forming an etched area 240, above which the oxide layer 220 are suspended. The said etching finally removes the photoresists 230, resulting in FIG. 2E.

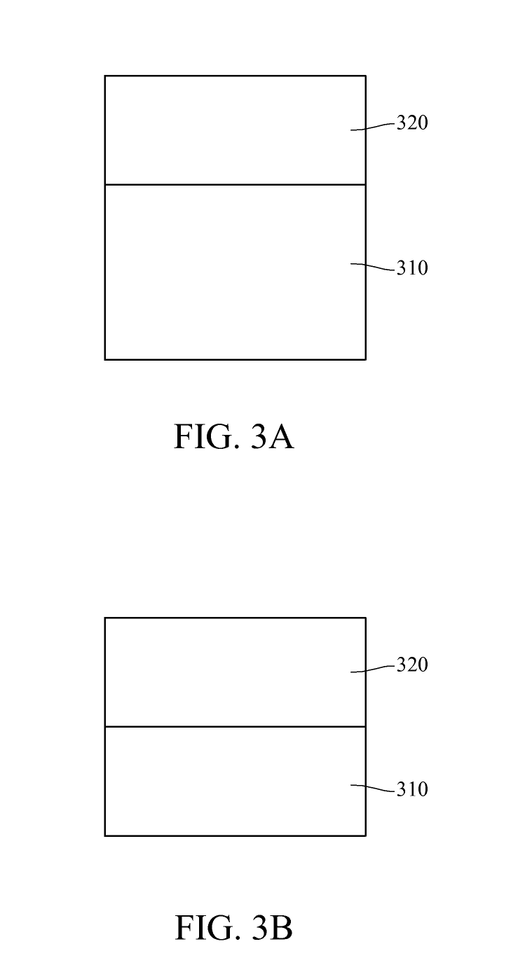

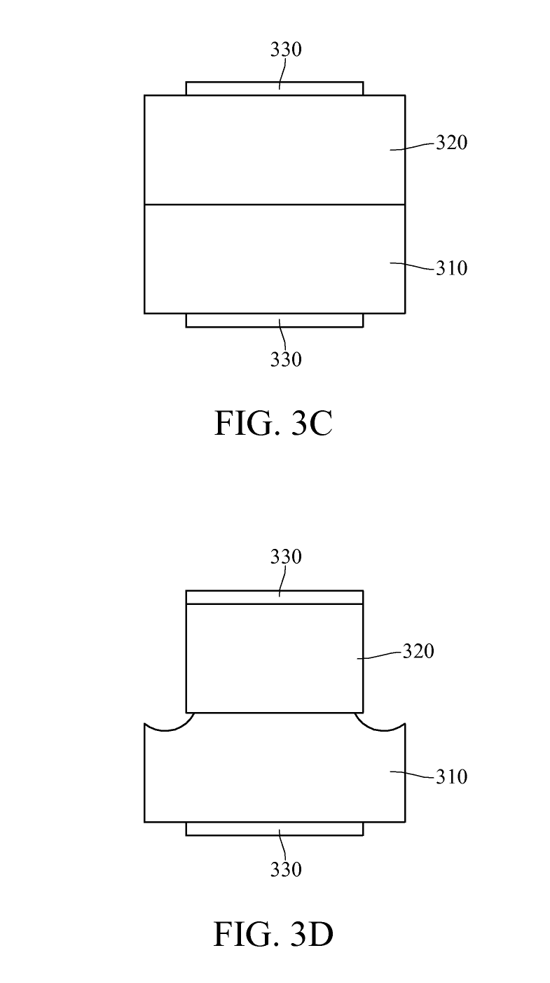

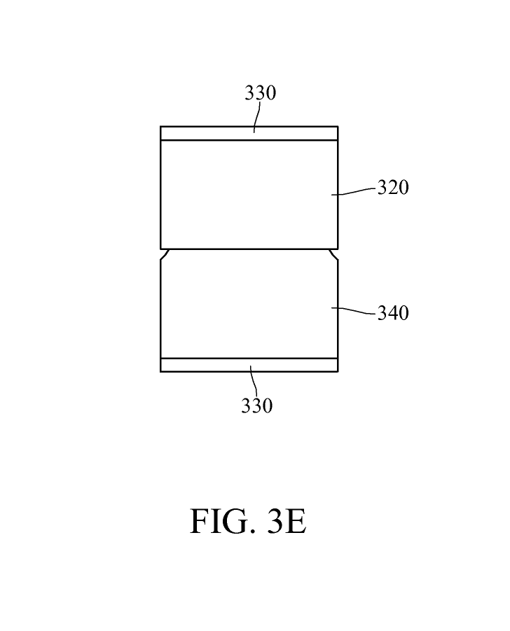

Please refer to FIGS. 3A through 3E, which illustrates another manufacturing process of the MEMS apparatus 100 in accordance to the second embodiment. In FIG. 3A, a covering layer 320 is grown on a substrate 310 by means of thin film deposition, before or after which step the substrate 310 is thinned using chemical-mechanical planarization (CMP), as shown in FIG. 3B. In FIG. 3C, photoresists 330 are applied on top of the covering layer 320 and on the back of the substrate 310. Using photolithography, the resists 330 define a hard mask protecting portions of the structure that are to be kept. As shown in FIG. 3D, the unprotected portions of the covering layer 320 are dry-etched away. The anisotropic dry etching may be, but not necessarily, reactive-ion etching, for example one based on inductively coupled plasma. The unprotected portions of the substrate 310 are also cut through by the said etching, the substrate 310 becoming a silicon substrate 340. The said etching finally removes the photoresists 330, resulting in FIG. 3E.

To summarize, the structure and movement of the MEMS apparatus are highly stable and not susceptible to the variation of temperature because its proof mass is constructed as an oxide layer optionally enclosing a connecting layer or as a silicon substrate optionally with a covering layer.

What is claimed is:

1. A MEMS (microelectromechanical systems) apparatus comprising:
a substrate comprising first electrodes, second electrodes, a first region, a second region, and an etched area, the etched area located at the center of the substrate, the first region and the second region opposite each other, the first electrodes equidistantly located in the first region, the second electrodes equidistantly located in the second region;
a proof mass disposed at the center of the substrate and comprising third electrodes, fourth electrodes, a first edge, and a second edge, the first edge and the second edge opposite each other, the third electrodes equidistantly located on the first edge, the fourth electrodes equidistantly located on the second edge; and
beams respectively disposed between a periphery of the substrate and a periphery of the proof mass and configured to support the proof mass so that the proof mass and the substrate are a first distance apart;
wherein each of the first electrodes, parallel to an axis, extends along the axis towards the first edge from the first region by a second distance, and each of the third electrodes, parallel to the axis, extends along the axis towards the first region from the first edge by a third distance, the first electrodes and the third electrodes opposite to and interlaid with each other, the second distance and the third distance greater than half of but no greater than the first distance;
wherein each of the second electrodes, parallel to the axis, extends along the axis towards the second edge from the second region by the second distance, and each of the fourth electrodes, parallel to the axis, extends along the axis towards the second region from the second edge by the third distance, the second electrodes and the fourth electrodes opposite to and interlaid with each other.

2. The MEMS apparatus of claim 1, wherein the substrate is made of silicon.

3. The MEMS apparatus of claim 1, wherein the proof mass is made of silicon dioxide.

4. The MEMS apparatus of claim 3, wherein the coefficient of thermal expansion of the proof mass is 0.5 ppm/° C.

5. The MEMS apparatus of claim 4, wherein the proof mass further comprises a connecting layer made of tungsten.

6. The MEMS apparatus of claim 5, wherein the coefficient of thermal expansion of the connecting layer is 4 ppm/° C.

7. The MEMS apparatus of claim 1, wherein the coefficient of thermal expansion of the proof mass is 3 ppm/° C.

8. The MEMS apparatus of claim 7, wherein the proof mass further comprises a covering layer made of metal or oxide.

9. The MEMS apparatus of claim 8, wherein the coefficient of thermal expansion of the covering layer is 0.5 ppm/° C.

10. The MEMS apparatus of claim 1, wherein the beams are made of metal.
